(19) United States
(12) Patent Application Publication
(10) Pub. No.: US 2020/0348907 A1
(43) Pub. Date: Nov. 5, 2020

(54) METHOD AND COMPUTING SYSTEM FOR SORTING POSITION-DEPENDENT DATA ARRAYS

(71) Applicant: EMC IP Holding Company LLC, Hopkinton, MA (US)

(72) Inventors: Jonathan I. Krasner, Coventry, RI (US); Chakib Ouarraoui, Watertown, MA (US)

(21) Appl. No.: 16/399,380

(22) Filed: Apr. 30, 2019

(51) Int. Cl. G06F 7/08; G06F 16/22; G06T 1/20

(52) U.S. Cl. CPC G06F 7/08; G06T 1/20; G06F 16/2264

(57) ABSTRACT

A method and computing system for sorting position-dependent data arrays. Specifically, the method and computing system disclosed herein entail: first, sorting one position-dependent data array according to a desired sorting order; and second, permuting the remaining position-dependent data arrays, based on the sorted position-dependent data array, in order to maintain the same relative positions of the various data stored across the position-dependent data arrays. Through this aforementioned sorting of position-dependent data arrays, a GPU may produce sorted structure of arrays from unsorted structure of arrays.

### BACKGROUND

Graphics Processing Units (GPUs) tend to work best with a structure of arrays (or disparate arrays) rather than an array of structures, which are best manipulated by Central Processing Units (CPUs). When translating the array of structures to the structure of arrays, each array of the structure of arrays subsequently maps to a structure of the array of structures.

### BRIEF DESCRIPTION OF DRAWINGS

FIG. 1 shows a host device in accordance with one or more embodiments of the invention.

FIG. 2 shows a flowchart describing a method for sorting position-dependent data arrays in accordance with one or more embodiments of the invention.

FIGS. 3A-3D show an example scenario in accordance with one or more embodiments of the invention.

FIG. 4 shows a computing system in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

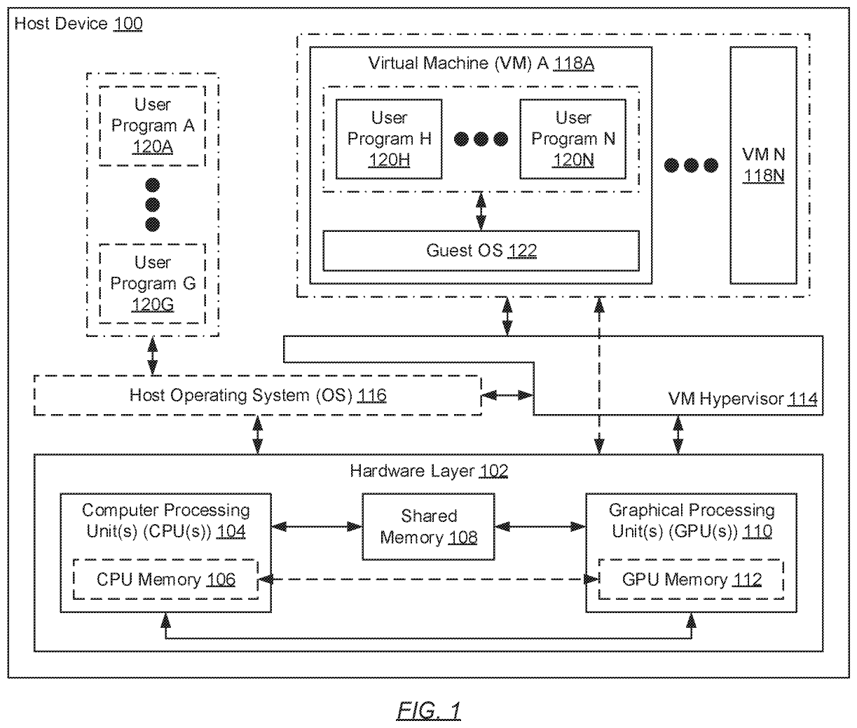

In the following description of FIGS. 1-4, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments of the invention relate to a method and computing system for sorting position-dependent data arrays. Specifically, one or more embodiments of the invention entails: first, sorting one position-dependent data array according to a desired sorting order; and second, permuting the remaining position-dependent data arrays, based on the sorted position-dependent data array, in order to maintain the same relative positions of the various data stored across the position-dependent data arrays. Through this aforementioned sorting of position-dependent data arrays, a GPU may produce sorted structure of arrays from unsorted structure of arrays.

With respect to database storage, many legacy applications, which rely on serial processing, store data as an array of structures (AoS). An AoS may refer to a data layout used to arrange a sequence of records in memory, where each record (i.e., a composite data structure including two or more data fields) is stored as one contiguous memory block. Subsequently, in an AoS, the data in different data fields, across all records, are interleaved sequentially in memory, thereby facilitating un-coalesced memory access. From the perspective of parallel processing, however, it is preferable to store data as a structure of arrays (SoA). A SoA may refer to another data layout used to arrange a sequence of records in memory, where each data field, across all records, is stored contiguously. Accordingly, in a SoA, no data interleaving occurs, thereby enabling coalesced memory accesses, which lends to the efficient usage of available memory bandwidth and higher global memory performance.

Upon further examination, a SoA is substantively a parallel array data structure that maintains a separate, homogeneous array for each data field of a record, where each array includes the same number of elements representative of the cardinality of records. Therefore, the two or more parallel arrays of a SoA store related data, where the related elements of each array are accessed with a common index. Based on this characteristic, the parallel arrays of a SoA are said to be position-dependent with respect to one another. When an operation (e.g., like sorting) is performed on one parallel array that impacts the arrangement of its elements, however, there lacks an implicit mechanism that rearranges the other parallel arrays accordingly, to maintain the aforementioned positional dependency across the set of parallel arrays. Implementations of one or more embodiments of the invention may improve the processing perform. For example, in one implementation, a series of tests were performed on a two-million row database. The result of applying embodiments of the invention to process the aforementioned database was an improved performance of between 3 and 15 times over processing the same database without embodiments of the invention.

FIG. 1 shows a host device in accordance with one or more embodiments of the invention. The host device (100) may represent any physical appliance or computing system designed and configured to receive, generate, process, store, and/or send data. Examples of the host device (100) may include, but are not limited to, a desktop computer, a tablet computer, a laptop computer, a server, a mainframe, or any other computing system similar to the exemplary computing system shown in FIG. 4. Furthermore, in one embodiment of the invention, the host device (100) may include any subset or all of the following components: a hardware layer (102), a virtual machine hypervisor (114), a host operating system (OS) (116), one or more virtual machines (118A-118N), and one or more user programs (120A-120N). Each of these host device (100) components is described below.

In one embodiment of the invention, the hardware layer (102) may represent a portion of the host device (100) architecture that includes various physical and/or tangible components. Collectively, these various physical and/or tangible components may enable and provide the framework and resources on which various logical components of the host device (100) may operate. Accordingly, the hardware layer (102) may include, but is not limited to, two or more computer processors represented through one or more central processing units (CPUs) (104) and one or more graphics processing units (GPUs) (110), as well as memory, which may exist as dedicated CPU/GPU memory (106, 112) and/or shared memory (108). Each of these hardware layer (102) subcomponents is described below.

In one embodiment of the invention, a CPU (104) may represent an integrated circuit designed and configured for processing instructions (e.g., computer readable program code). A CPU (104) may encompass one or more cores, or micro-cores, which may be optimized to execute sequential or serial instructions at high clock speeds. Further, a CPU (104) may be more versatile than a GPU (110) and, subsequently, may handle a diversity of functions, tasks, and/or activities. Towards processing instructions, a CPU (104) may, on occasion and for specific computational tasks, interact with one or more GPUs (110) (described below).

In one embodiment of the invention, with respect to interacting with one or more GPUs (110), a CPU (104) may include functionality to: copy input data (i.e., data to be processed) from dedicated CPU memory (106) (described below) to dedicated GPU memory (112) (described below), or alternatively, identify the memory address of input data residing in shared memory (108) (described below); invoke the GPU(s) (110) to process the input data either stored in the dedicated GPU memory (112) or the shared memory (108), where for the latter, the aforementioned memory address may be provided to enable the GPU(s) to locate and retrieve the input data; receive a notification, from the GPU(s) (110), that output data (i.e., results from processing the input data) have been copied from the dedicated GPU memory (112) to the dedicated CPU memory (106), or alternatively, have been stored in the shared memory (108) at another memory address; and retrieve the output data from either the dedicated CPU memory (106) or the shared memory (108), where for the latter, the aforementioned other memory address may be used to locate the output data therein for retrieval. One of ordinary skill will appreciate that a CPU (104) may perform other functionalities without departing from the scope of the invention.

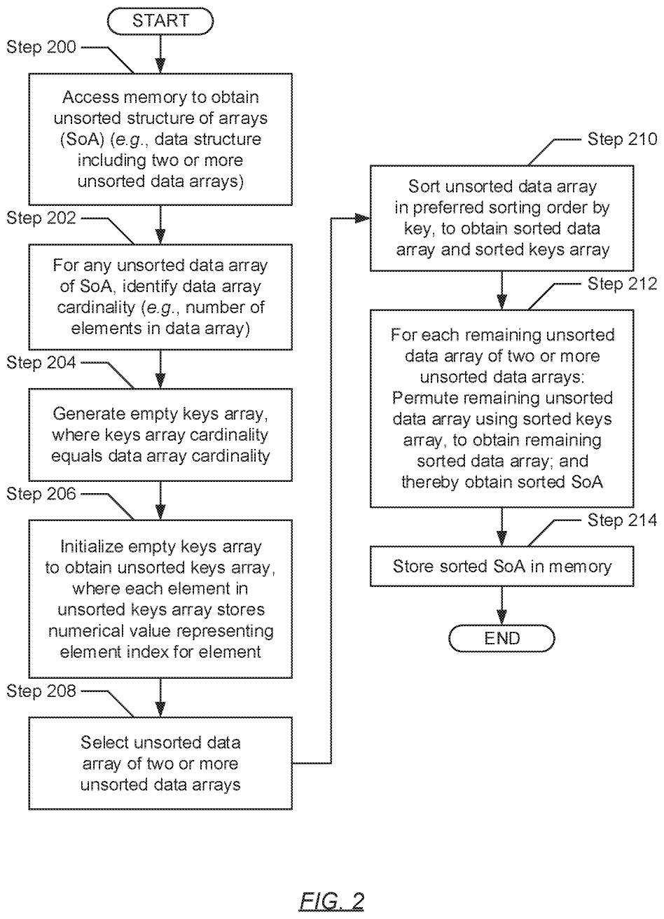

In one embodiment of the invention, a GPU (110) may represent a specialized CPU (or integrated circuit) designed and configured to render graphics and/or perform specific computational tasks. A GPU (110) may encompass hundreds or thousands of cores, or micro-cores, which may be optimized to execute parallel operations at slower clock speeds. Through their massively parallel architecture, a GPU (110) may be superior to a CPU (104) in processing power, memory bandwidth, speed, and efficiency when executing tasks that predominantly require multiple parallel processes such as, for example, graphics rendering, machine learning, big data analysis, etc. A GPU (110) may include functionality to sort position-dependent data arrays in accordance with one or more embodiments of the invention (see e.g., FIG. 2).

In one embodiment of the invention, with respect to interacting with one or more CPUs (104), a GPU (110) may include functionality to: receive instructions (or invocation) from the CPU(s) (104), which may be directed to performing a specific task involving input data copied into dedicated GPU memory (112) or residing in shared memory (108) at a disclosed memory address; retrieve the input data from either the dedicated GPU memory (112) or the shared memory (108); execute parallel processes using the input data, to perform the aforementioned specific task and to obtain output data; copy the output data from the dedicated GPU memory (112) to the dedicated CPU memory (106), or alternatively, store the output data in the shared memory (108) at another memory address; and issue a notification, to a CPU (104), that the output data may be retrieved from the dedicated CPU memory (106) or the shared memory (108) at the disclosed other memory address. One of ordinary skill will appreciate that a GPU (110) may perform other functionalities without departing from the scope of the invention.

In one embodiment of the invention, dedicated CPU memory (106) may refer to physical memory that may only be accessible to one or more CPUs (104). The dedicated CPU memory (106) may or may not be integrated into the CPU(s) (104). Further, the dedicated CPU memory (106) may be implemented using any volatile physical memory such as, for example, dynamic random access memory (DRAM) or static random access memory (SRAM).

In one embodiment of the invention, dedicated GPU memory (112) may refer to physical memory that may only be accessible to one or more GPUs (110). The dedicated GPU memory (106) may or may not be integrated into the GPU(s) (110). Further, the dedicated GPU memory (112) may be implemented using any specialized volatile physical memory such as, for example, video random access memory (VRAM). VRAM may be similar to DRAM with the exceptions of being faster than DRAM and exhibiting the capability of being written to and read from simultaneously.

In one embodiment of the invention, shared memory (108) may refer to physical memory that may be accessible to at least one or more CPUs (104) and one or more GPUs (110). Accordingly, the shared memory (108) may be accessible to additional components of the hardware layer (102), which may include, but is not limited to, physical storage (not shown) and one or more network adapters (not shown). Further, the shared memory (108) may be implemented using any volatile physical memory such as, for example, DRAM or SRAM.

In one embodiment of the invention, returning to the host device (100) components, the virtual machine (VM) hypervisor (114) may refer to a computer program that executes over the hardware layer (102) and may be responsible for managing one or more VMs (118A-118N). Thus, the VM hypervisor (114) may include functionality to: create or delete a VM (118A-118N); allocate or deallocate host device (100) resources (e.g., computing, memory, storage, network bandwidth, etc.) to support the execution of the VM(s) (118A-118N) and their respective workload; and facilitate communication between the VM(s) (118A-118N) and the hardware layer (102) and/or other VM(s) (118A-118N). With respect to facilitating communications between the VM(s) (118A-118N) and the hardware layer (102), the VM hypervisor (114) may, in one embodiment of the invention, include further functionality to access, interpret, and utilize one or more hardware device drivers (not shown). Each hardware device driver may refer to a special computer program that enables interaction with a specific hardware component (e.g., CPU (104), GPU (110), storage (not shown), etc.) installed on the host device (100). In another embodiment of the invention, the VM hypervisor (114) may alternatively facilitate communications between the VM(s) (118A-118N) and the hardware layer (102) via the host OS (116) should one be installed on the host device (100). In this other embodiment, the host OS (116) may have access to the aforementioned hardware device drivers, in order to interact with the hardware layer (102), rather than the VM hypervisor (114). One of ordinary skill will appreciate that the VM hypervisor (114) may perform other functionalities without departing from the scope of the invention.

In one embodiment of the invention, the host OS (116), if installed on the host device (100), may refer to a computer program that executes over the hardware layer (102) and may be responsible for managing utilization of the hardware layer (102) by the various logical (or software) components (e.g., user program(s) (120A-102G), VM hypervisor (114), etc.) executing on the host device (100). Accordingly, the host OS (116) may include functionality to, for example, support fundamental host device (100) functions; schedule tasks; allocate host device (100) resources; execute or invoke other computer programs; and control peripherals (e.g., input and output devices (not shown)). Furthermore, towards managing the utilization of the hardware layer (102), the host OS (116) may include further functionality to access, interpret, and use one or more hardware device drivers (described above). One of ordinary skill will appreciate that the host OS (116) may perform other functionalities without departing from the scope of the invention.

In one embodiment of the invention, a virtual machine (VM) (118A-118N) may refer to a computer program designed and configured to emulate a physical computing system (see e.g., FIG. 4). To that extent, a VM (118A-118N) may provide a self-contained execution environment within which one or more user programs (120H-120N) (described below) and a guest OS (122) may execute. Briefly, the guest OS (122) may refer to a computer program that implements an operating system responsible for managing the emulated computing system deployed in the VM (118A-118N). Further, the guest OS (112) may execute an operating system that is similar or different than the host OS (116). In one embodiment of the invention, a VM (118A-118N) may interact with the hardware layer (102) indirectly through the issuance of system calls that may be trapped and processed by the VM hypervisor (114) and/or the host OS (116). In another embodiment of the invention, a VM (118A-118N) may alternatively interact with the hardware layer (102) directly using a peripheral component interconnect (PCI) passthrough, which assigns exclusive access to one or more hardware devices to the VM (118A-118N). In this latter embodiment, the VM (118A-118N) may also include further functionality to access, interpret, and use any hardware device drivers pertaining to any hardware components with which the VM (118A-118N) may directly interact. One of ordinary skill will appreciate that a VM (118A-118N) may perform other functionalities without departing from the scope of the invention.

In one embodiment of the invention, a user program (120A-120N) may refer to a computer program designed and configured to perform one or more functions, tasks, and/or activities directed to aiding a user of the host device (100). Accordingly, towards performing these operations, a user program (120A-120N) may include functionality to request and consume host device (100) resources (e.g., computing, memory, storage, network bandwidth, etc.), provided by the hardware layer (102), through the host OS (116), the VM hypervisor (114), or the guest OS (122) (if applicable). One of ordinary skill will appreciate that a user program (120A-120N) may perform other functionalities without departing from the scope of the invention. Examples of a user program (120A-120N) may include, but are not limited to, a word processor, an email client, a database client, a web browser, a media player, a file viewer, an image editor, a simulator, a game, a big data analyzer, a machine learning based application, etc.

While FIG. 1 shows a configuration of components, other host device (100) configurations may be used without departing from the scope of the invention.

FIG. 2 shows a flowchart describing a method for sorting position-dependent data arrays in accordance with one or more embodiments of the invention. The various steps outlined below may be performed by a graphics processing unit (GPU) (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 2, in Step 200, memory is accessed to obtain an unsorted structure of arrays (SoA). In one embodiment of the invention, the memory being accessed may refer to dedicated GPU memory residing on and accessible only to the GPU. In another embodiment of the invention, the memory being accessed may refer to shared memory external, and accessible, to both the GPU and one or more central processing units (CPUs). Generally, a SoA may represent a composite data type or record (e.g., a struct) that defines a grouped list of variables that may be accessed using a single pointer and references a contiguous block of the memory. The aforementioned grouped list of variables may include one or more variables, which may be directed to similar or different data types (e.g., integers, floats, characters, strings, etc.).

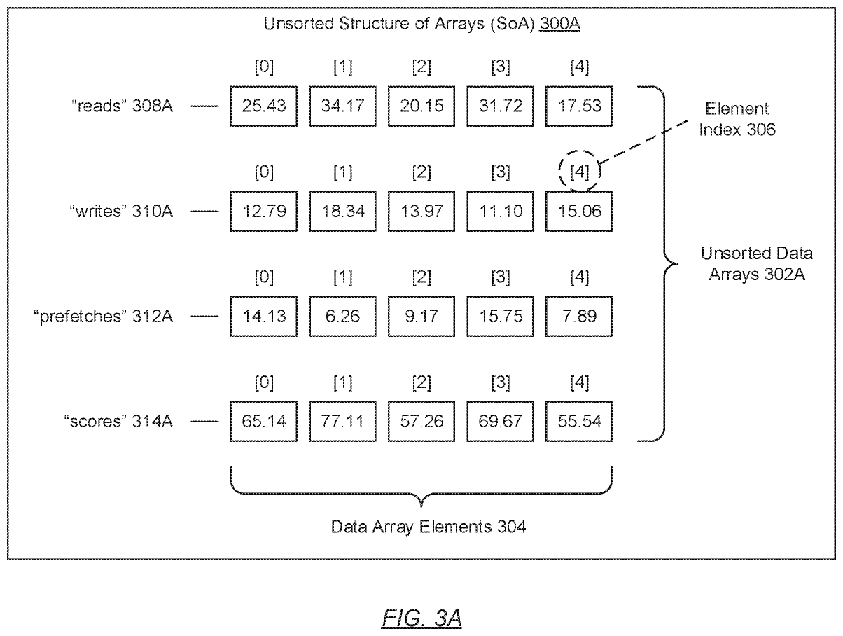

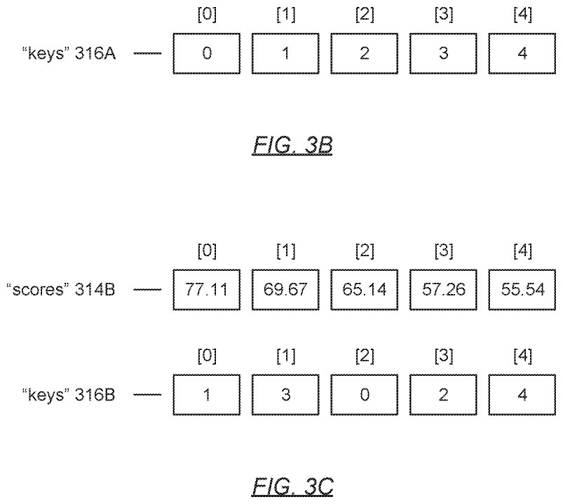

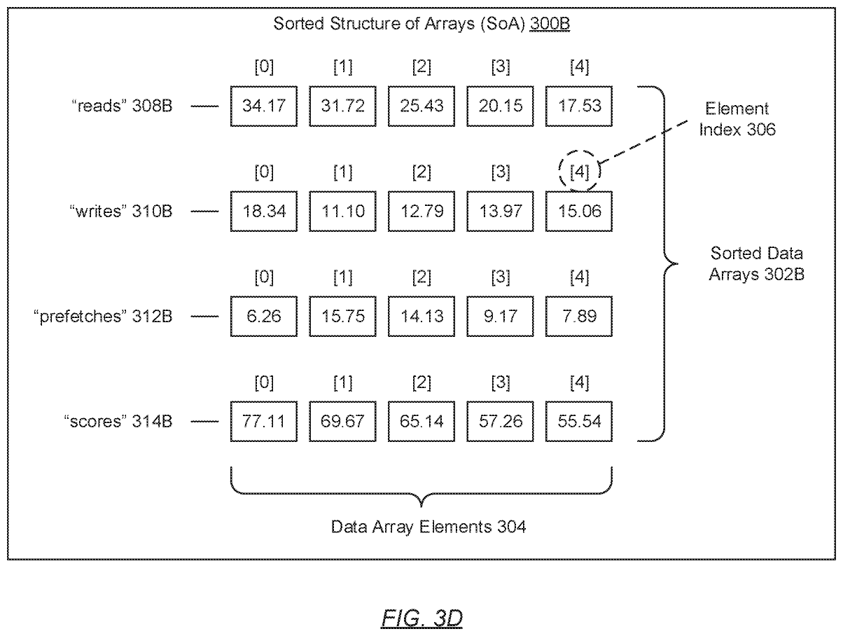

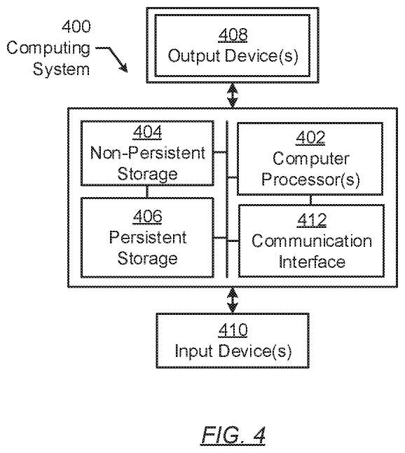

In one embodiment of the invention, the above-mentioned unsorted SoA may represent a composite data type or record that includes or specifies two or more variables. Each of the variables may be an unsorted position-dependent data array of a given data type, which may share a common cardinality (i.e., number of elements or length). The data types associated with the unsorted position-dependent data arrays may be directed to similar or different data types. Fundamentally, a data array may refer to a data structure including a collection of elements, each of which store a value or variable (also referred herein as element content) and may be identified by way of an index indicating the location or position of the element along the length of the data array in sequential order (see e.g., FIG. 3A).

In one embodiment of the invention, a position-dependent data array may refer to a data array, where each element (identified by a given index) relates or maps to one or more other elements of one or more other position-dependent data arrays, respectively, which is/are also identified by the given index. For example, consider there being three position-dependent data arrays—e.g., a first position-dependent data array, a second position-dependent data array, and a third position-dependent data array. The three position-dependent data arrays may share a common cardinality of four, thereby indicating that each of the three position-dependent data arrays include four elements. Further, per the aforementioned definition, each element, at a given index, across the three position-dependent data arrays relate, map, or link to one another. That is, a first element of the first position-dependent data array, which may be identified by a first index, may relate to a first element of the second and third position-dependent data arrays, which may also be identified by the first index. Moreover, a second element of the first position-dependent data array, identified by a second index, may relate to a second element of the second and third position-dependent data arrays, also identified by the second index; and so forth for the remaining two elements of the four elements enumerating the common cardinality of the three position-dependent data arrays.

In one embodiment of the invention, an unsorted position-dependent data array may refer to a position-dependent data array, where the values or variables stored across the collection of elements are not arranged per a defined sequence (or sorting order). By way of examples, a defined sequence (or sorting order) may include, but are not limited to, a descending order where the values or variables (e.g., directed to integers, floats, or any other numerical data type) stored across the collection of elements are arranged from largest to smallest; an ascending order where the values or variables (e.g., directed integers, floats, or any other numerical data type) across the collection of elements are arranged from smallest to largest; and an alphabetical order where the values or variables (e.g., directed to a character or a string of characters) across the collection of elements are arranged based on the position of the characters in the conventional ordering of an alphabet.

In Step 202, a common cardinality shared between the two or more unsorted position-dependent data arrays, of the unsorted SoA (obtained in Step 200), is identified. In one embodiment of the invention, the common cardinality may refer to the number of elements specified by each of the two or more unsorted position-dependent data arrays. That is, the cardinality of a first unsorted position-dependent data array should match or equal the cardinality of a second unsorted position-dependent data array, a cardinality of a third unsorted position-dependent data array (if present), and so forth.

In Step 204, an empty keys data array, having a cardinality matching the common cardinality (identified in Step 202), is generated. In one embodiment of the invention, the empty keys data array may refer to a data array, where each element in the collection of elements stores a null value (or is otherwise empty). A null value may refer to a missing value (or variable) or a blank.

In Step 206, the empty keys data array (generated in Step 204) is initialized to obtain an unsorted keys data array. In one embodiment of the invention, initialization of the empty keys data array may entail storing, in each element of the collection of elements, a numerical value (e.g., integer) representative of the index with which the respective element identifies. For example, consider an exemplary empty keys data array including the following collection of five elements expressed through the notation [index]=value: {[0]=null; [1]=null; [2]=null; [3]=null; [4]=null}. Initialization of this exemplary empty keys data array may result in an exemplary unsorted keys data array that includes the following collection of five elements expressed through the notation [index]=value: {[0]=0; [1]=1; [2]=2; [3]=3; [4]=4}.

In Step 208, an unsorted position-dependent data array (of the two or more unsorted position-dependent data arrays) is selected. In one embodiment of the invention, selection of the unsorted position-dependent data array may depend on user preference or input, which may specify from which unsorted position-dependent data array should sorting of all unsorted position-dependent data arrays be based.

In Step 210, the unsorted position-dependent data array (selected in Step 208) is sorted, by key, in accordance with a preferred sequence (or sorting order). In one embodiment of the invention, the preferred sequence (or sorting order) may refer to a default sorting order or a user-selected sorting order. By way of examples, the preferred sequence (or sorting order) may include, but are not limited to, a descending order where the values or variables (e.g., directed to integers, floats, or any other numerical data type) stored across the collection of elements are arranged from largest to smallest; an ascending order where the values or variables (e.g., directed integers, floats, or any other numerical data type) across the collection of elements are arranged from smallest to largest; and an alphabetical order where the values or variables (e.g., directed to a character or a string of characters) across the collection of elements are arranged based on the position of the characters in the conventional ordering of an alphabet. Furthermore, based on the sorting of the unsorted position-dependent data array, a sorted position-dependent data array and a sorted keys data array are obtained. The sorted position-dependent data array may refer to the adjustment of the unsorted position-dependent data array such that the values or variables stored across the collection of elements are arranged per the aforementioned preferred sequence (or sorting order). On the other hand, the sorted keys data array may refer to the adjustment of the unsorted keys data array (obtained in Step 206) such that the indices stored across the collection of elements are arranged to align with the adjustment performed to the unsorted position-dependent data array.

For example, consider an exemplary unsorted position-dependent data array, which would have been selected in Step 208, that includes the following collection of five elements expressed through the notation [index]=value: {[0]=35; [1]=90; [2]=26; [3]=71; [4]=55}. Further, from above, recall the exemplary unsorted keys data array, which would have been obtained in Step 206, that includes the following collection of five elements expressed through the notation [index]=value: {[0]=0; [1]=1; [2]=2; [3]=3; [4]=4}. Now, assume the exemplary unsorted position-dependent data array is sorted in descending order, thereby resulting in an exemplary sorted position-dependent data array including the following collection of five elements expressed through the notation [index]=value: {[0]=90; [1]=71; [2]=55; [3]=35; [4]=26}. Accordingly, the exemplary unsorted keys data array would be rearranged to obtain an exemplary sorted keys data array that includes the following collection of five elements expressed through the notation [index]=value: {[0]=1; [1]=3; [2]=4; [3]=0; [4]=2}. Looking at it another way, the sorted keys data array may store the element indices corresponding to the elements of the unsorted position-dependent data array when sorted per the preferred sorting order.

In Step 212, for each remaining unsorted position-dependent data array (of the two or more unsorted data arrays), the remaining unsorted position-dependent data array is permuted using the sorted keys data array (obtained in Step 210). In one embodiment of the invention, a remaining sorted position-dependent data array may subsequently result from the permutation applied to a respective remaining unsorted position-dependent data array. More specifically, the values or variables stored in the collection of elements of a remaining unsorted position-dependent data array may be rearranged according to the new sequence of indices represented by the sorted keys data array. By way of an example, consider there being an exemplary remaining unsorted position-dependent data array that includes the following collection of five elements expressed through the notation [index]=value: {[0]=07; [1]=44; [2]=16; [3]=29; [4]=81}. Subsequently, permutation of exemplary remaining unsorted position-dependent data array, based on the above-mentioned exemplary sorted keys data array, would result in an exemplary remaining sorted position-dependent data array that includes the following collection of five elements expressed through the notation [index]=value: {[0]=44; [1]=29; [2]=81; [3]=07; [4]=16}.

In one embodiment of the invention, following the rearrangement of each remaining unsorted position-dependent data array, a sorted SoA is obtained. In contrast to the unsorted SoA (obtained in Step 200), the sorted SoA may represent a composite data type or record that includes or specifies two or more variables, where each of the variables refer to a sorted position-dependent data array. Further, the values or variables stored in the collection of elements, representative of each sorted position-dependent data array, may be arranged per the preferred sorting order (mentioned in Step 210) based upon the sequence of values or variables stored in the sorted position-dependent data array (obtained in Step 210).

In Step 214, the sorted SoA (obtained in Step 212) is subsequently consolidated in the memory (e.g., dedicated GPU memory or shared memory) from which the unsorted SoA had been obtained (in Step 500). Specifically, in one embodiment of the invention, the sorted SoA may be consolidated in a separate contiguous block of the memory.

In one embodiment of the invention, the sorted SoA may subsequently be used: (a) to present the records spanning across the sorted position-dependent data arrays in an ordered manner; (b) to ease and/or expedite searching and access to specific records; and (c) as input into other processing algorithms such as compression, deduplication, and machine learning. The invention is not limited to the aforementioned examples.

FIGS. 3A-3D show an example scenario in accordance with one or more embodiments of the invention. The following example scenario, presented in conjunction with components shown in FIGS. 3A-3D, is for explanatory purposes only and not intended to limit the scope of the invention.

Turning to FIG. 3A, consider the unsorted structure of arrays (SoA) (300A) portrayed herein. The unsorted SoA (300A), which may have been retrieved from dedicated GPU memory or shared memory, represents a composite data type or record that defines four unsorted position-dependent data arrays (302A). These four unsorted position-dependent data arrays (302A) include: an unsorted “reads” position-dependent data array (308A) (hereinafter referred to as the unsorted “reads” data array); an unsorted “writes” position-dependent data array (310A) (hereinafter referred to as the unsorted “writes” data array); an unsorted “prefetches” position-dependent data array (312A) (hereinafter referred to as the unsorted “prefetches” data array); and an unsorted “scores” position-dependent data array (314A) (hereinafter referred to as the unsorted “scores” data array). Furthermore, for this non-limiting example scenario, assume the objective is to obtain a sorted SoA (not shown) based on the sorting of the unsorted “scores” data array (314A) in a descending order.

Subsequently, turning to FIG. 3B, an unsorted “keys” data array (316A) is generated, as portrayed herein. Recall that the unsorted “keys” data array (316A) is generated to exhibit the common cardinality (or number of elements) associated with the four unsorted position-dependent data arrays (302A) (shown in FIG. 3A), and further, stores—in each element—a numerical value representative of the element index for the element.

Thereafter, turning to FIG. 3C, the unsorted “scores” data array (314A) is sorted in the above-mentioned descending order (i.e., the preferred sorting order), to obtain a sorted “scores” position-dependent data array (314B) (hereinafter referred to as the sorted “scores” data array). Similarly, the unsorted “keys” data array (316A) is also rearranged based on the sorting of the unsorted “scores” data array (314A) in order to yield a sorted “keys” data array (316B). The sorted “keys” data array (316B) thus stores a resulting sequence of element indices, pertaining to the unsorted “scores” data array (314A), which describe the rearrangement of the values or variables of the unsorted “scores” data array (314A) that yields the sorted “scores” data array (314B) in the desired descending order.

Turning to FIG. 3D, a sorted SoA (300B), representative of the above-mentioned sought objective, is portrayed herein. The sorted SoA (300B) refers to a composite data type or record that defines four sorted position-dependent data arrays (302B). These four sorted position-dependent data arrays (302B) include: a permutation of the unsorted “reads” data array (308A) based on the sorted “keys” data array (316B), thereby producing a sorted “reads” position-dependent data array (308B); a permutation of the unsorted “writes” data array (310A) based on the sorted “keys” data array (316B), thereby producing a sorted “writes” position-dependent data array (310B); a permutation of the unsorted “prefetches” data array (312A) based on the sorted “keys” data array (316B), thereby producing a sorted “prefetches” position-dependent data array (312B); and the sorted “scores” data array (314B) produced through sorting the unsorted “scores” data array (314A) in the desired descending order.

FIG. 4 shows a computing system in accordance with one or more embodiments of the invention. The computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a central processing unit (CPU) and/or a graphics processing unit (GPU). The computing system (400) may also include one or more input devices (410), such as a touchscreen, keyboard, mouse, microphone, touchpad, electronic pen, or any other type of input device. Further, the communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

In one embodiment of the invention, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for producing a sorted structure of arrays (SoA), comprising:
obtaining an unsorted SoA comprising a plurality of unsorted position-dependent data arrays;
selecting an unsorted position-dependent data array from the plurality of unsorted position-dependent data arrays;
sorting the unsorted position-dependent data array according to a preferred sorting order, to obtain a sorted position-dependent data array; and
permuting each remaining unsorted position-dependent data array of the plurality of unsorted position-dependent data arrays, based at least on the sorted position-dependent data array, to produce the sorted SoA,
wherein the sorted SoA is used to expedite data searching and access.

2. The method of claim 1, wherein the method is performed by a graphics processing unit (GPU).

3. The method of claim 1, wherein the preferred sorting order is one selected from a group consisting of an ascending order and a descending order.

4. The method of claim 1, further comprising:
prior to selecting the unsorted position-dependent data array:
identifying a common cardinality associated with the plurality of unsorted position-dependent data arrays; and
generating an unsorted keys data array comprising a first collection of elements,
wherein each element of the first collection of elements stores a numerical value indicating an element index associated with the element of the first collection of elements,
wherein a cardinality of the first collection of elements matches the common cardinality.

5. The method of claim 4, further comprising:
prior to permuting each remaining unsorted position-dependent data array:
rearranging the first collection of elements of the unsorted keys data array based on the sorted position-dependent data array, to obtain a sorted keys data array comprising a second collection of elements.

6. The method of claim 5, wherein the second collection of elements stores a sequence of element indices that map to a sequence of element content stored by a third collection of elements, wherein the sequence of element content is produced by sorting the unsorted position-dependent data array according to the preferred sorting order, wherein the sorted position-dependent data array comprises the third collection of elements.

7. The method of claim 6, wherein permuting each remaining unsorted position-dependent data array based at least on the sorted position-dependent data array, to produce the sorted SoA, comprises:
for each remaining unsorted position-dependent data array comprising a fourth collection of elements:
rearranging the fourth collection of elements based on the sequence of element indices, to obtain a fifth collection of elements,
wherein the sorted SoA comprises a plurality of sorted position-dependent data arrays.

8. A computing system, comprising:
a first computer processor; and
a memory accessible to the first computer processor, wherein the first computer processor is programmed to:
obtain, from the memory, an unsorted structure of arrays (SoA) comprising a plurality of unsorted position-dependent data arrays;
select an unsorted position-dependent data array from the plurality of unsorted position-dependent data arrays;
sort the unsorted position-dependent data array according to a preferred sorting order, to obtain a sorted position-dependent data array; and
permute each remaining unsorted position-dependent data array of the plurality of unsorted position-dependent data arrays, based at least on the sorted position-dependent data array, to produce a sorted SoA,
wherein the sorted SoA is used to expedite data searching and access.

9. The computing system of claim 1, wherein the first computer processor is a graphics processing unit (GPU).

10. The computing system of claim 9, wherein the memory is a dedicated GPU memory accessible only to the GPU.

11. The computing system of claim 9, wherein the memory is a shared memory accessible to at least the GPU.

12. The computing system of claim 9, further comprising:
a second computer processor operatively connected to the first computer processor, and programmed to invoke the first computer processor to produce the sorted SoA from the unsorted SoA.

13. The computing system of claim 12, wherein the second computer processor is a central processing unit (CPU).

14. A non-transitory computer readable medium (CRM) comprising computer readable program code, which when executed by a computer processor, enables the computer processor to:
obtain an unsorted structure of arrays (SoA) comprising a plurality of unsorted position-dependent data arrays;
select an unsorted position-dependent data array from the plurality of unsorted position-dependent data arrays;
sort the unsorted position-dependent data array according to a preferred sorting order, to obtain a sorted position-dependent data array; and
permute each remaining unsorted position-dependent data array of the plurality of unsorted position-dependent data arrays, based at least on the sorted position-dependent data array, to produce a sorted SoA,
wherein the sorted SoA is used to expedite data searching and access.

15. The non-transitory CRM of claim 14, wherein the computer processor is a graphics processing unit (GPU).

16. The non-transitory CRM of claim 14, wherein the preferred sorting order is one selected from a group consisting of an ascending order and a descending order.

17. The non-transitory CRM of claim 14, further comprising computer readable program code, which when executed by the computer processor, further enables the computer processor to:
prior to selecting the unsorted position-dependent data array:
identify a common cardinality associated with the plurality of unsorted position-dependent data arrays; and
generate an unsorted keys data array comprising a first collection of elements,
wherein each element of the first collection of elements stores a numerical value indicating an element index associated with the element of the first collection of elements,
wherein a cardinality of the first collection of elements matches the common cardinality.

18. The non-transitory CRM of claim 17, further comprising computer readable program code, which when executed by the computer processor, further enables the computer processor to:
prior to permuting each remaining unsorted position-dependent data array:
rearrange the first collection of elements of the unsorted keys data array based on the sorted position-dependent data array, to obtain a sorted keys data array comprising a second collection of elements.

19. The non-transitory CRM of claim 18, wherein the second collection of elements stores a sequence of element indices that map to a sequence of element content stored by a third collection of elements, wherein the sequence of element content is produced by sorting the unsorted position-dependent data array according to the preferred sorting order, wherein the sorted position-dependent data array comprises the third collection of elements.

20. The non-transitory CRM of claim 19, further comprising computer readable program code, which when executed by the computer processor, further enables the computer processor to:
permute each remaining unsorted position-dependent data array comprising a fourth collection of elements by:
rearranging the fourth collection of elements based on the sequence of element indices, to obtain a fifth collection of elements,
wherein the sorted SoA comprises a plurality of sorted position-dependent data arrays.
